(19) United States
(12) Patent Application Publication
(10) Pub. No.: US 2004/0203462 A1
(43) Pub. Date: Oct. 14, 2004

(54) Method and apparatus for setting the threshold of a power control target in a spread spectrum communication system

(76) Inventors: Wei Lin, San Diego, CA (US); Yuan Kang Lee, San Diego, CA (US); Chiang-Hwa Shen, Poway, CA (US)

Correspondence Address: TEXAS INSTRUMENTS INCORPORATED, P O BOX 655474, M/S 3999, DALLAS, TX, 75265

(21) Appl. No.: 10/303,189

(22) Filed: Nov. 25, 2002

(51) Int. Cl. H04B 17/00; H04B 1/00; H04B 7/00

(52) U.S. Cl. 455/67.13; 455/69; 455/70

(57) ABSTRACT

A communication system and method for revising an updated target signal to interference ratio (SIR) ensure that the updated target SIR does not fall below a threshold target SIR that is required to ensure a specified minimum quality of service. In one aspect, the present invention provides a method for controlling an updated target signal to interference ratio in a communication system. In this method 180, an updated target signal to interference ratio is received (block 182). A threshold signal to interference ratio is established (block 184) and the updated target signal to interference ratio and the threshold signal to interference ratio are compared (block 186). The updated target signal to interference ratio is then set equal to the threshold signal to interference ratio if the updated target signal to interference ratio is less than the threshold signal to interference ratio (block 188).

### CROSS-REFERENCE TO RELATED APPLICATIONS

This application is related to the following co-pending and commonly assigned patent applications: Serial No.______, filed concurrently herewith and entitled “Method and Apparatus for Low Power-Rise Power Control Using Sliding Window Weighted QOS Measurements” (Attorney Docket No. TI-34260) and Serial No.______, filed concurrently herewith and entitled “Method and Apparatus for Fast Convergent Power Control in a Spread Spectrum Communication System” (Attorney Docket No. TI-34261). Both of these applications are hereby incorporated herein by reference.

### TECHNICAL FIELD

The present invention relates generally to an apparatus and method for power control in a communication system, and more particularly to an apparatus and method for adjusting the power control target and minimizing signal dropouts by ensuring the power control target greater than or equal to a threshold.

### BACKGROUND

Power control is commonly used in communication systems for minimizing transmission power while maintaining the received signal quality at the desired level. In a code division multiple access (CDMA) spread spectrum communication system, since one user's signal contributes to other users' noise, power control is essential to mitigate the near-far problem and improve the system capacity. Furthermore, in order to minimize power consumption while ensuring a specified minimum quality of service (QoS) under varying channel conditions, the power control target, which is typically a threshold for the received signal to interference ratio (SIR), is updated autonomously to adapt to the change of communication environments. The QoS is typically specified in terms of a block error rate (BLER) or a bit error rate (BER). Examples of such communication systems include those operating under the IS-95, IS-2000, UMTS/WCDMA and TD-SCDMA standards.

For example, in a UMTS/WCDMA system (the UMTS/WCDMA standard can be found at http://www.3gpp.org), an open loop power control scheme is used for determining an initial transmission power at the start of a transmission. A closed loop power control scheme is used to adjust the ongoing transmission power to warrant the specified minimum QoS. The closed loop power control scheme includes both an inner loop power control system and an outer loop power control system. The inner loop power control system in a receiver estimates the received SIR and compares it to the power control target SIR_{target}. If the estimated SIR is greater than the target SIR_{target}, the receiver generates a power down command that is sent to the transmitter. Conversely, if the estimated SIR is lower than SIR_{target}, the receiver generates a power up command that is sent to the transmitter. The transmitter then adjusts the transmission power based on the decoded received power control commands. This inner loop power control system operates at a 1,500 Hz update rate. The outer loop power control system uses an algorithm to control SIR_{target} by adjusting it such that the specified minimum QoS is achieved at minimum power all the time.

A significant concern in the SIR_{target} update algorithm is the resulting power-rise. Power rise is defined as the difference between the actual average transmitted power and the minimum transmitted power required to meet the specified minimum QoS. The smaller (and non-negative) the power-rise, the better the SIR_{target} update algorithm for several reasons. A larger power-rise results in reduced system capacity due to the nature of a spread spectrum communication system. This excess transmitted power reduces the battery life for a mobile terminal such as a cellular telephone. The excess transmitted power also produces un-necessary interference to other mobile receivers.

If the transmitted power is lower than that required to warrant the specified minimum QoS, communication will suffer high error rate or even dropouts may occur.

A prior art SIR_{target} update algorithm 100 is illustrated in FIG. 1a. In this prior art, a receiver receives a series of data blocks, one block at each time. Each block can be determined as a good block or a bad block based on, for example, the result of a CRC check. Upon decoding the current data block, the block is checked for errors 102. If an error occurs, the SIRtarget update algorithm steps up SIR_{target} by an integer multiple K of a fixed increment A as shown by 104. If no error occurs, the SIR_{target} update algorithm would step down SIR_{target} by the fixed increment Δ as shown by 106. By using fixed increments, significant overshoot and undershoot occurred. It should also be noted that this prior art SIR_{target} update algorithm bases its SIR_{target} update on just the current data block. This memory-less operation will produce large power-rise under steady channel conditions when the SIR_{target} is expected to be as constant as possible.

An alternative SIR_{target} update algorithm is based upon the proportional-integral-derivative (PID) controller as shown in FIG. 1b. This approach filters the difference between the specified minimum QoS (labeled as “Desired QoS”) and the actual QoS and then updates SIR_{target} based upon this difference. It should be noted that in this prior art the actual QoS is computed from all the previously received data blocks. Under varying channel conditions, the SIR_{target} is expected to track and compensate the change of channel as quickly as possible. This full-memory operation, however, responses slowly to the change of channel, and results in significant overshoot and undershoot, and therefore high power-rise.

In order to minimize the power rise, the power control target is expected to be as constant as possible under steady channel conditions. While the channel conditions are changing, the power control target is expected to follow the change as quickly as possible. Furthermore, the less the variation of the power control target around the ideal value, the less the resulting power rise. This can be achieved by limiting the power control target always larger than or equal to a carefully determined value.

Additionally, if the power control target undershoot occurs, extra power would be needed subsequently to compensate the loss such that overall the specified minimum QoS is guaranteed. The problem of power control target undershoot is especially acute in multi-data-rate (MDR) communication systems. In MDR communication systems, the required power control target for a specified QoS varies as a function of the data rate. For example, at rate-1, the SIR_{target} will be significantly smaller than the SIR target at rate-2. Therefore, when a MDR communication system is transmitting at a rate-1 using the prior art power control target update algorithm, the system is likely to have signal dropouts if the data rate suddenly change to rate-2 as the SIR_{target} may not follow fast enough. Therefore, there is a need to set a lower threshold on the power control target such that the chance of power control target undershoot is minimized under all channel conditions and all transmission rates.

### SUMMARY OF THE INVENTION

These and other problems are generally solved or circumvented, and technical advantages are generally achieved, by preferred embodiments of the present invention that reduce power control target SIR_{target} undershoots. By avoiding SIR_{target} undershoot, the preferred embodiments of the present invention reduce signal dropouts and power rise.

In accordance with a first embodiment of the present invention, a method for controlling an updated target signal to interference ratio SIR_{target} in a communication system is disclosed. In the first embodiment, an updated SIR target and a threshold SIR are known by the communication device (e.g., either computed by the device or received from a remote device). The updated target SIR and the threshold SIR are compared. If the updated target SIR is less than the threshold SIR, then the updated target SIR is set equal to the threshold SIR.

An advantage of embodiments of the present invention is that it reduces SIR_{target} undershoot that leads to signal dropout in a communication system such as a cellular telephone. The present invention therefore allows for more aggressive minimizing of power-rise.

Yet another advantage of embodiments of the present invention is that by reducing power-rise, self-generated interference is reduced. By reducing self-interference, a specified minimum QoS can be maintained at lower transmission power levels. Embodiments also reduce power-rise that consumes transmission power in a PCD. By minimizing transmission power, a battery's operating time in a PCD can be extended.

A further advantage of the preferred embodiment of the present invention is that by minimizing power-rise, more PCDs can operate from a single base station while maintaining a specified minimum QoS, respectively. This increase in the number of PCDs for each base station reduces the number of required base stations, thereby reducing overall communication system costs.

The foregoing has outlined rather broadly the features and technical advantages of the present invention in order that the detailed description that follows may be better understood. Additional features and advantages of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWING

For a more complete understanding of the present invention, and the advantages thereof, reference is now made to the following descriptions taken in conjunction with the accompanying drawing, in which:

FIG. 1a is a flowchart of the prior art target SIR control system;

FIG. 1b is a block diagram of a portion of a prior art communication system;

FIG. 2 is an overview of a telecommunications system that can incorporate an embodiment of the present invention;

FIG. 3 is an overview of a personal communication device that can incorporate an embodiment of the present invention;

FIG. 4 illustrates the data structure for a communication system that can incorporate an embodiment of the present invention; and

FIG. 5 is a flowchart of an embodiment of the present invention.

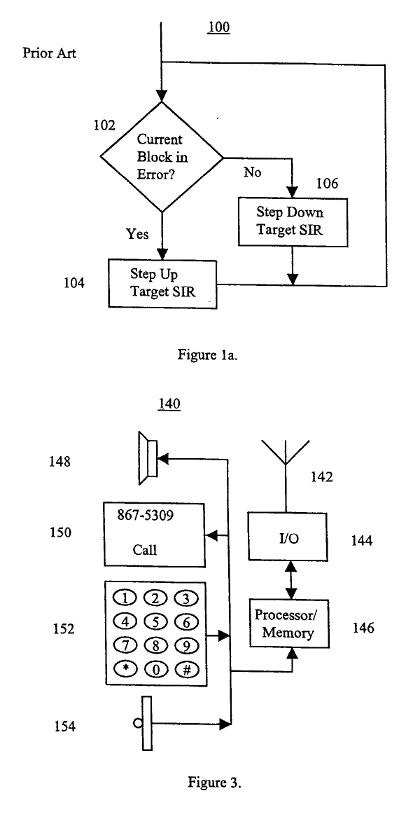

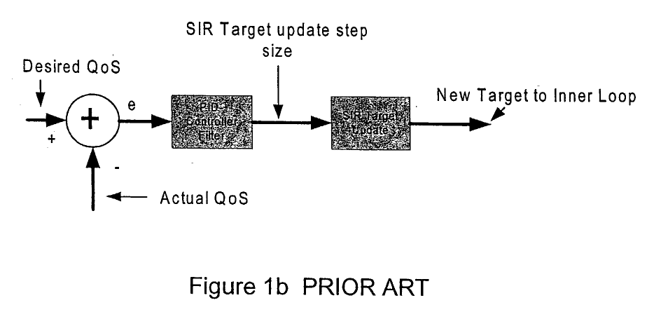

### DETAILED DESCRIPTION

A process and a system for implementing this process of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a personal communication device (PCD), such as a cellular telephone or a personal digital assistant (PDA). The invention may also be applied, however, to other communication systems.

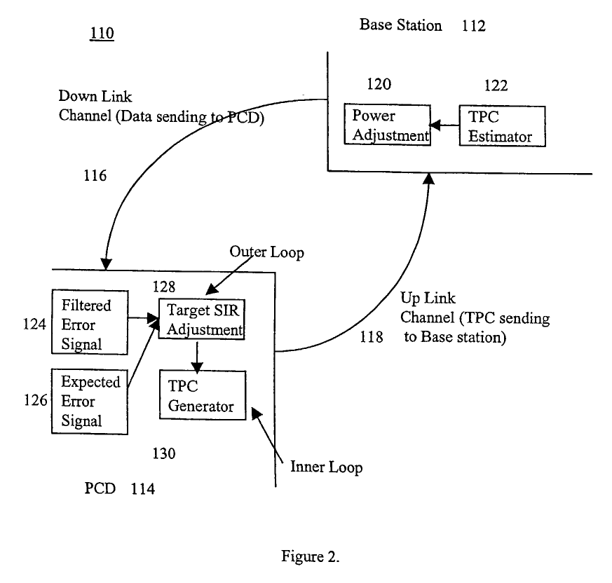

FIG. 2 shows an overview of a communication system 110. The system includes both a base station 112 and a PCD 114. The base station 112 and the PCD 114 transmit and receive data via a down link channel 116 and an up link channel 118. Performance of the base station 112 is optimized in part by a power adjustment 120 received from a transmission power command (TPC) estimator 122. Performance of the PCD 114 is optimized in part by adjusting the target signal to interference ratio (SIR_{target}) in an outer loop power control and generating the TPC in an inner loop power control. This optimization uses filtered error signal data 124, expected error calculation data 126, target SIR adjustment data 128 and a TPC generator 130. The filtered error signal data 124 is used for target SIR adjustment 128. The expected error calculation data 126 is used in target SIR adjustment 128. Lastly, the target SIR adjustment 128 is used in the TPC generator 130.

An example PCD 114 in the form of a cellular telephone 140 is illustrated in FIG. 3. The cellular telephone 140 includes an antenna 142, an input/output section 144, a processor/memory unit 146, a speaker 148, a display panel 150, a keypad 152 and a microphone 154. Data frames are received by the antenna 142, modified by the input/output section 144 and provided to the processor/memory unit 146. The processor/memory unit 146 may also receive data from the keypad 152 or the microphone 154. The processor/memory unit 146 may display data on the display panel 148 or output sounds to the speaker 148. While the processor/memory unit 146 is illustrated as a single element, a separate processor and a separate memory may also be used. A digital signal processor (DSP) may also be used as the processor/memory unit 146.

Since the specified minimum quality of service (QoS) is frequently a function of, or equal to, the Block Error Rate (BLER) or the Bit Error Rate (BER), the BLER will be used to represent the QoS without loss of generality throughout the remainder of this description. A BLER of 1% may be adequate for voice-only communication applications while a BLER of 10% will typically be required for data communication applications.

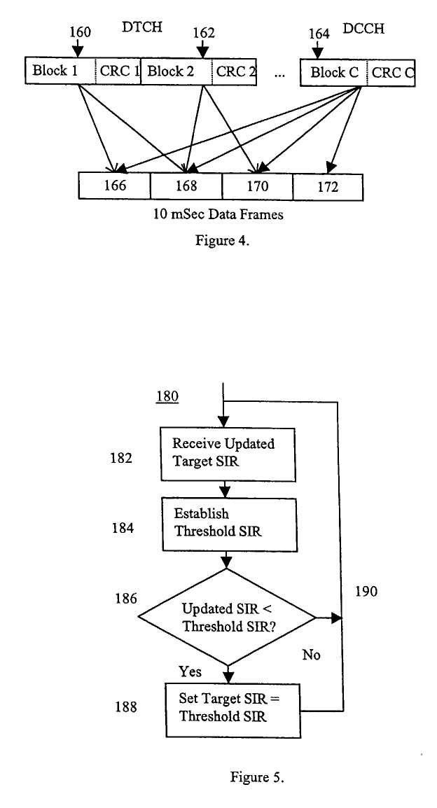

The PCD 114 receives a series of data frames 166-172 from the base station 112 via the down link channel 116 as shown in FIG. 4. As an example, we assume the transmission is for AMR voice specified by UMTS/WCDMA standards. Transmission of the data frames is at one of K different data rates. Each data frame contains data from a dedicated traffic channel (DTCH) and a dedicated control channel (DCCH). The DTCH is used for transmitting data, which in the case of a cellular telephone 140 corresponds to the user's voice, and is composed of individual data blocks 160, 162. Each of the individual data blocks includes N cyclic redundancy check (CRC) bits for error checking. The individual data blocks may have from 0 to M bits. The actual size of a data block in a UMTS/WCDMA compliant communication system is determined by an adaptive multi-rate coder/decoder (AMR CODEC). The AMR CODEC varies the size of the data blocks depending upon the user's voice activity. Each DTCH data block is first padded with the N CRC bits and then encoded with the user's voice data using convolutional coding.

The DCCH is used for transmitting voice signaling and control information. The DCCH block either contains 0 bits (zero rate) or L bits with L>0 (full rate). Finally, the DCCH is also padded with N CRC bits for error checking followed by convolutional coding, if it contains L bits. In the case of a zero rate DCCH data block, no CRC bit padding is used. According to the UMTS/WCDMA standard, the values of K, N, M and L are in the following ranges: 0<K<17, 0<N<25, −1<M<505 and −1<L<505. In one example from the UMTS/WCDMA standard, K=9, N=12, M=81 and L=100.

Before transmission, processing occurs with rate matching, interleaving, multiplexing, and other steps. The DTCH data block is then spread over two consecutive data frames as shown in FIG. 4. The DCCH data block is spread over four consecutive data frames, also shown in FIG. 4.

A receiver, for example a PCD 114, determines the BLER using the CRC bits for both the DTCH. It should be noted that the BLER is determined for the DCCH only when L>0, i.e., non-zero rate conditions. The DCCH typically will have L=0, except when control information, such as for soft handoff, is transmitted. Conversely, the DTCH data blocks are always padded with CRC bits and thus undergo BLER determination for each DTCH data frame. For this reason, the preferred embodiment updating SIR_{target} algorithm uses the DTCH data frame BLER to adjust the SIR_{target}.

Returning to the example of a cellular phone 140 conversation, when voice activity is very low, such as during a period when the other user is listening, the DTCH data blocks contain no information bits. (In this case, reference is made to the “other” user since the amount of voice data received will be dependent upon the person talking to the user of the phone 140.) This period of little activity will generally lead to very low BLER and the PCD 114 will step down the SIR_{target} a number of times.

Problems can arise when the other user starts talking, thereby increasing the DTCH data rate, or when the DCCH must transmit control information. At this time, the SIR_{target} is too low to support reliable data transmission. In this case, the received DTCH or DCCH data blocks will not be decodable and the chance of dropouts will increase significantly. As a numerical example, if the DTCH data block comprises only 12-bits prior to the other user speaking and increases to 120-bits when the other user starts speaking, the SIR_{target} must increase approximately 2 dB for a 1% BLER. If the updating SIR_{target} algorithm has allowed the SIRtarget to step down too far, this sudden increase in SIR_{target} may result in dropouts.

The threshold SIR_{target} algorithm of the present invention minimizes the data dropout rate just described. The process flow of the threshold SIR_{target} algorithm 180 is shown in FIG. 5 and may be used in conjunction with an updating SIR_{target} algorithm. The algorithm described here can be used with any SIR_{target} algorithm. Two such algorithms are described in co-pending applications Serial No. (TI-34260) and Serial No. (TI-34261). Both of these applications are incorporated herein by reference as if reproduced in their entirety.

The threshold SIR_{target} algorithm 180 first receives an updated SIR_{target} from the updating SIR_{target} algorithm, as shown by block 182. For example, the updating algorithm may be running on processor 146 within the PCD 140. The processor 146 may cause the updated SIR_{target} to be stored in a data register or other memory within the PCD 140 (or elsewhere). In this case, the SIR_{target} would be “received” from the data register or other memory. In other examples, the SIR_{target} could be remotely calculated and received at the antenna 142.

The threshold SIR_{target} algorithm 180 next establishes a threshold SIRₜₕᵣₑₛₕ, as shown by block 184. The threshold SIRₜₕᵣₑₛₕ can be established in any of a number of ways. For example, the threshold SIRₜₕᵣₑₛₕ can be determined by the PCD and stored in memory. This determination can occur once, e.g., at start-up, or can happen periodically. Alternatively, the threshold SIRₜₕᵣₑₛₕ can be determined by a remote device such as base station and transmitted to the PCD 140.

The threshold SIR_{target} algorithm 180 then compares the updated SIR_{target} and the threshold SIRₜₕᵣₑₛₕ as shown by block 186. When the updated SIR_{target} is not less than the threshold SIRₜₕᵣₑₛₕ, the updated SIR_{target} is not further modified. However, if the updated SIR_{target} falls below the threshold SIRₜₕᵣₑₛₕ, the threshold SIR_{target} algorithm upwardly revises the SIR_{target} to the threshold SIRₜₕᵣₑₛₕ, as shown by block 188. In either case, the threshold SIR_{target} algorithm returns to step 182 via loop 190 and awaits receipt of the next updated SIR_{target}.

Several different methods exist for determining the threshold SIRₜₕᵣₑₛₕ. For example, assume that the K data transmission rates correspond to R₁, R₂, . . . R_{K}. For data transmission rate Rᵢ, there exists a minimum SIR_{target} required to meet a given QoS. This minimum SIR_{target} will be denoted by SIR_{i,Qos}. In other words, under no channel conditions will the QoS be met if SIR_{target} falls below SIR_{i,Qos} for this rate SIR_{i,Qos} is preferably determined under additive white Gaussian noise (AWGN) channel conditions.

In a first preferred method for determining SIRₜₕᵣₑₛₕ, a ceiling function could be used according to Equation 1:

$${SIR}_{thresh} = {max}_{i} \{ {SIR}_{i , QoS} \} . \qquad Eq . 1$$

In a second preferred method, SIRₜₕᵣₑₛₕ could be computed using a weighted average according to Equation 2:

$${SIR}_{thresh} = {\sum }_{i} {p}_{i} * {SIR}_{i , QoS} , \qquad Eq . 2$$

wherein

$${\sum }_{i} {p}_{i} = 1.$$

Each pᵢ is preferably the probability of data transmission rate Rᵢ, though this is not required.

A third preferred method for determining SIRₜₕᵣₑₛₕ uses the threshold SIRₜₕᵣₑₛₕ computed according to either of the first two methods, but adds a SIR enhancement factor Δₜₕᵣₑₛₕ to ensure the QoS is met. The enhancement factor can be additive or multiplicative, as two examples. The appropriate SIR enhancement factor Δₜₕᵣₑₛₕ will be a trade-off of average transmitted power and average system performance. In a typical embodiment Δₜₕᵣₑₛₕ will be between about −0.5 and 0.5.

The SIRₜᵣₑₛₕ can be predetermined and, in the cellular phone 140 example, stored in the processor/memory unit 146. Alternatively, the SIRₜₕᵣₑₛₕ could be received by the cellular phone 140 from the base station 112. In this case, the base station 112 could monitor the number of cellular phones 140 in use and, considering the relative occurrence of the data transmission rates Rᵢ, the topology, the weather, and other factors, compute and transmit a revised SIRₜₕᵣₑₛₕ. The additional information available to the base station 112 is especially useful when using the third method as the SIR enhancement factor Δₜₕᵣₑₛₕ can be determined more accurately.

In other embodiments, either or both of SIRₜₕᵣₑₛₕ and the enhancement factor Δₜₕᵣₑₛₕ can be determined dynamically by the PCD 114. For example, the PCD 114 can monitor the data transmission rates and update the weighting factors pᵢ of Equation 2 based upon the data transmission rate history. As another example, the Aₜₕᵣₑₛₕ value can be updated by monitoring the error rates and the changes in error rates. Alternatively, either SIRₜₕᵣₑₛₕ or Δₜₕᵣₑₛₕ can be updated by the base station 112 based upon the same monitoring.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, means, methods and steps described in the specification. As one of ordinary skill in the art will readily appreciate from the disclosure of the present invention, processes, machines, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, means, methods, or steps.

What is claimed is:

1. A process for controlling an updated target signal to interference ratio in a communication system, the process comprising:
receiving an updated target signal to interference ratio;
establishing a threshold signal to interference ratio;
comparing the updated target signal to interference ratio and the threshold signal to interference ratio; and
setting the updated target signal to interference ratio equal to the threshold signal to interference ratio if the updated target signal to interference ratio is less than the threshold signal to interference ratio.

2. A process in accordance with claim 1, wherein the communication system comprises a multi-data rate communication system and wherein establishing the threshold signal to interference ratio comprises:
establishing a minimum signal to interference ratio for each possible data transmission rate; and
setting the threshold signal to interference ratio equal to the maximum of the minimum signal to interference ratios.

3. A process in accordance with claim 2, wherein establishing the threshold signal to interference ratio further comprises increasing the threshold signal to interference ratio by an signal to interference ratio enhancement factor.

4. A process in accordance with claim 3, wherein the signal to interference ratio enhancement factor is received from a remote device.

5. A process in accordance with claim 1, wherein establishing the threshold signal to interference ratio comprises:
establishing a minimum signal to interference ratio for each possible data transmission rate;
weighting each minimum signal to interference ratio; and
combining together each of the weighted minimum signal to interference ratios, thereby generating the threshold signal to interference ratio.

6. A process in accordance with claim 5, wherein each minimum signal to interference ratio is weighted according to a probability of a respective possible data transmission rate.

7. A process in accordance with claim 5, wherein establishing the threshold signal to interference ratio further comprises modifying the threshold signal to interference ratio based on a signal to interference ratio enhancement factor.

8. A process in accordance with claim 7, wherein the signal to interference ratio enhancement factor is received from a remote device.

9. A process in accordance with claim 1, and further comprising computing the updated target signal to interference ratio prior to receiving the updated target signal to interference ratio.

10. A handheld communication device comprising:
an antenna;
a signal input/output section coupled to the antenna;
a user interface; and
a processor, the processor coupled to the signal input/output section and the user interface, wherein
the processor is adapted to receive an updated target signal to interference ratio;
the processor is adapted to establish a threshold signal to interference ratio;
the processor is adapted to compare the updated target signal to interference ratio and the threshold signal to interference ratio; and
the processor is adapted to set the updated target signal to interference ratio equal to the threshold signal to interference ratio if the updated target signal to interference ratio is less than the threshold signal to interference ratio.

11. An apparatus in accordance with claim 10, wherein the processor is adapted to establish a threshold signal to interference ratio by establishing a minimum signal to interference ratio for each possible data transmission rate, and setting the threshold signal to interference ratio equal to the maximum of the minimum signal to interference ratios.

12. An apparatus in accordance with claim 11, wherein the processor is further adapted to increase the threshold signal to interference ratio by the signal to interference ratio enhancement factor.

13. An apparatus in accordance with claim 10, wherein the processor is adapted to establish a threshold signal to interference ratio by establishing a minimum signal to interference ratio for each possible data transmission rate and taking the weighted average of the minimum signal to interference ratios.

14. An apparatus in accordance with claim 13 wherein each minimum signal to interference ratio is weighted according to a probability of a respective possible data transmission rate.

15. An apparatus for use in a spread-spectrum, multi-data rate communication system, the apparatus comprising:
means for comparing an updated target signal to interference ratio (SIR) to a threshold SIR; and
means for setting the updated target SIR equal to the threshold SIR if the updated target SIR is less than the threshold SIR.

16. The apparatus of claim 15 and further comprising means for establishing the threshold SIR, the means for establishing comprising:
means for establishing a minimum SIR for each possible data transmission rate; and
means for setting the threshold SIR equal to the maximum of the minimum SIRs.

17. The apparatus of claim 16 wherein the means for establishing the threshold SIR further comprises means for increasing the threshold SIR by an SIR enhancement factor.

18. The apparatus of claim 17 and further comprising means for receiving the SIR enhancement factor from a remote device.

19. The apparatus of claim 15 and further comprising means for establishing the threshold SIR, the means for establishing comprising:
means for establishing a minimum signal to interference ratio for each possible data transmission rate;
means for weighting each minimum signal to interference ratio; and
means for combining together each of the weighted minimum signal to interference ratios, thereby generating the threshold signal to interference ratio.

20. The apparatus of claim 19 wherein each minimum signal to interference ratio is weighted according to a probability of a respective possible data transmission rate.
